(19) United States
(12) Patent Application Publication
(10) Pub. No.: US 2009/0251893 A1
(43) Pub. Date: Oct. 8, 2009

(54) LED flashlight with mechanical switch operable to adjust light brightness

(76) Inventor: Wen-Chin Shiao, Tao-Yuan Hsien (TW)

Correspondence Address: SCHWEGMAN, LUNDBERG & WOESSNER, P.A., P.O. BOX 2938, MINNEAPOLIS, MN, 55402, US

(21) Appl. No.: 12/221,842

(22) Filed: Aug. 7, 2008

(30) Foreign Application Priority Data
Apr. 2, 2008 (TW) 097111983

(51) Int. Cl. F21L 4/04

(52) U.S. Cl. 362/205

(57) ABSTRACT

An LED flashlight includes a conductive lamp-shielding barrel, a substrate, a conductive battery housing, a circuit board, and at least two conductive contact bars. When the lamp-shielding barrel is rotated relative to the battery housing to move the substrate toward the circuit board to a first position, a positive contact of the substrate is in electrical contact with one of the conductive contact bars so that the lamp unit emits a light of a first brightness. When the lamp-shielding barrel is further rotated relative to the battery housing to move the substrate toward the circuit board to a second position, the positive contact of the substrate is in electrical contact with both of the conductive contact bars so that the lamp unit emits a light of a second brightness that is different from the first brightness.

### CROSS-REFERENCE TO RELATED APPLICATION

This application claims priority of Taiwanese Application No. 097111983, filed on Apr. 2, 2008.

### BACKGROUND OF THE INVENTION

1. Field of the Invention

This invention relates to a flashlight, and more particularly to an LED flashlight that includes a mechanical switch operable to adjust the light brightness.

2. Description of the Related Art

To adjust the light brightness, an LED flashlight typically includes an integrated circuit board disposed on a lamp-mounting substrate. The lamp-mounting substrate is disposed within a conductive lamp-shielding barrel, and has a rear side surface formed with a central positive contact and an annular peripheral negative contact. When the lamp-shielding barrel is rotated relative to the battery housing, the integrated circuit board controls the electric currents flowing into a lamp unit on the lamp-mounting substrate to change the light brightness. However, due to the presence of the integrated circuit board, the manufacturing costs of the LED flashlight are increased.

### SUMMARY OF THE INVENTION

The object of this invention is to provide an LED flashlight that includes a mechanical switch operable to adjust the light brightness and that is manufactured at a low cost.

According to this invention, an LED flashlight comprises:

a conductive lamp-shielding barrel;

a substrate disposed fixedly within the lamp-shielding barrel and having a positive contact disposed at a central portion thereof, and an annular negative contact disposed along an outer periphery thereof and in electrical contact with the lamp-shielding barrel;

a lamp unit mounted to the substrate;

a conductive battery housing adapted for mounting of a battery set therewithin, the battery housing being connected rotatably to and in electrical contact with the lamp-shielding barrel and being rotatable relative to the lamp-shielding barrel so as to move toward and away from the lamp-shielding barrel; and

an electrical connection unit including
a circuit board disposed fixedly within the battery housing and having front and rear side surfaces, the rear side surface having a positive contact disposed at a central portion thereof and adapted for electrical contact with a battery set, and an annular negative contact disposed along an outer periphery of the circuit board and in electrical contact with the battery housing,
a resistor unit including at least two resistors attached to the front side surface of the circuit board and connected electrically to the positive contact of the circuit board, and
a contact unit including at least two conductive contact bars extending between the circuit board and the substrate along an axial direction and having front ends biased to different axial positions adjacent to the substrate, each of the conductive contact bars being connected electrically to the resistor unit;

wherein, when the lamp-shielding barrel is rotated relative to the battery housing to move the substrate toward the circuit board to a first position, the positive contact of the substrate is in electrical contact with one of the conductive contact bars so that the lamp unit emits a light of a first brightness; and when the lamp-shielding barrel is further rotated relative to the battery housing to move the substrate toward the circuit board to a second position, the positive contact of the substrate is in electrical contact with both of the conductive contact bars so that the lamp unit emits a light of a second brightness that is different from the first brightness.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly exploded perspective view of the first preferred embodiment of an LED flashlight according to this invention;

FIG. 2 is a schematic sectional view of the first preferred embodiment;

FIG. 3 is a schematic view of a substrate of the first preferred embodiment having a generally circular central positive contact aligned with two conductive contact bars, and an annular peripheral negative contact;

FIG. 4 is a schematic view of a front side surface of a circuit board of the first preferred embodiment that is mounted with two resistors;

FIG. 5 is a schematic view of a rear side surface of the circuit board of the first preferred embodiment;

FIG. 6 is a fragmentary sectional view of the first preferred embodiment, illustrating a first position of the substrate whereat the positive contact of the substrate is in electrical contact with a conductive long contact bar;

FIG. 7 is a fragmentary sectional view of the first preferred embodiment, illustrating a second position of the substrate whereat the positive contact of the substrate is in electrical contact with the long contact bar and a conductive short contact bar;

FIG. 8 is a schematic electrical circuit diagram illustrating an in-parallel electrical connection of two resistors of the first preferred embodiment;

FIG. 9 is a partly exploded perspective view of the second preferred embodiment of an LED flashlight according to this invention;

FIG. 10 is a fragmentary sectional view of the second preferred embodiment; and

FIG. 11 is a fragmentary sectional view of the third preferred embodiment of an LED flashlight according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

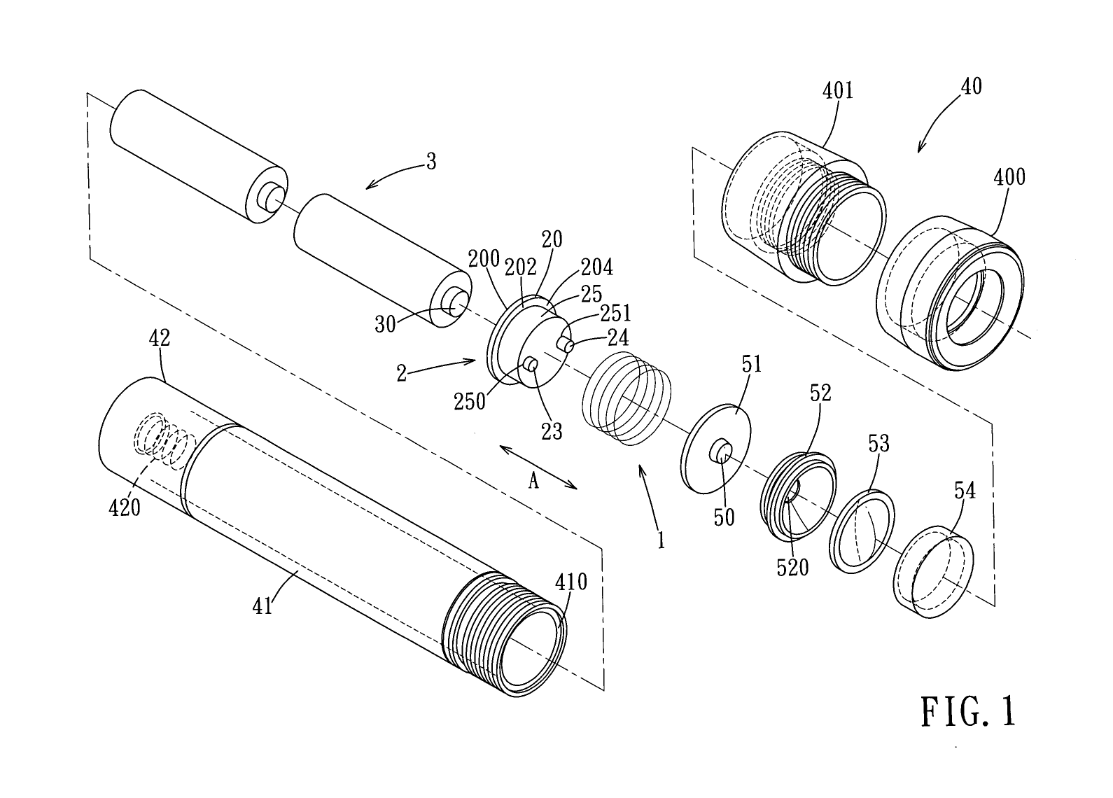

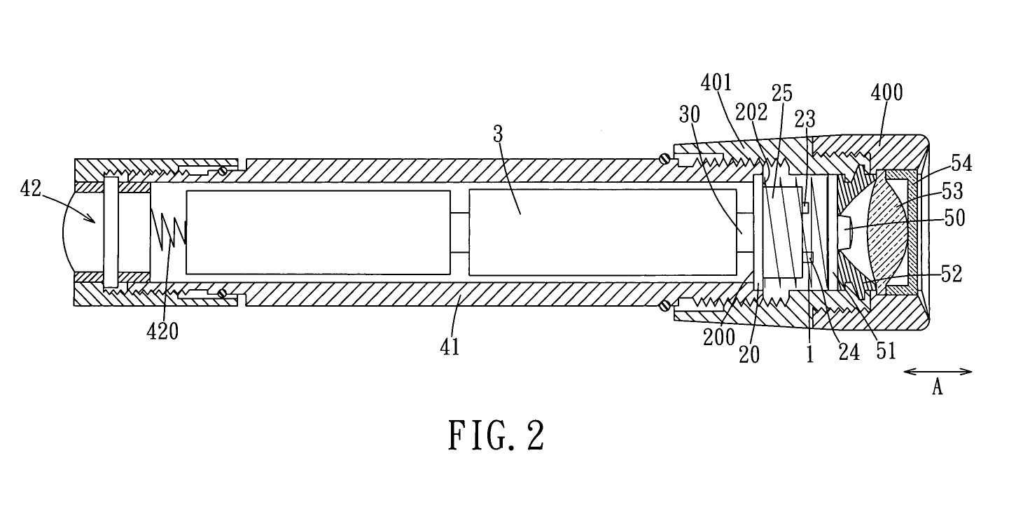

Referring to FIGS. 1 and 2, the first preferred embodiment of an LED flashlight according to this invention includes a conductive lamp-shielding barrel 40, a conductive battery housing 41, a pushbutton-type switch 42, a lamp unit including an LED lamp 50, a substrate 51, a condenser 52, a lens 53, a protective cap 54, and a switch device including a resilient member 1 and an electrical connection unit 2.

The lamp-shielding barrel 40 consists of a front barrel housing 400 and a rear barrel housing 401 that has an externally threaded front end portion engaging an internally threaded rear end portion of the front barrel housing 400. In this embodiment, the front and rear barrel housings 400, 401 and the battery housing 41 are made of an aluminum alloy. The battery housing 41 is adapted for mounting a battery set 3 therewithin, and has an externally threaded front end portion engaging an internally threaded rear end portion of the rear barrel housing 401. As such, the battery housing 41 is connected rotatably to and in electrical contact with the lamp-shielding barrel 40, and is rotatable relative to the lamp-shielding barrel 40 so as to move toward and away from the lamp-shielding barrel 40. The pushbutton-type switch 42 is disposed movably on a rear end of the battery housing 41, and includes a conductive battery-engaging spring 420 disposed therein and in electrical contact with a rear end of the battery set 3.

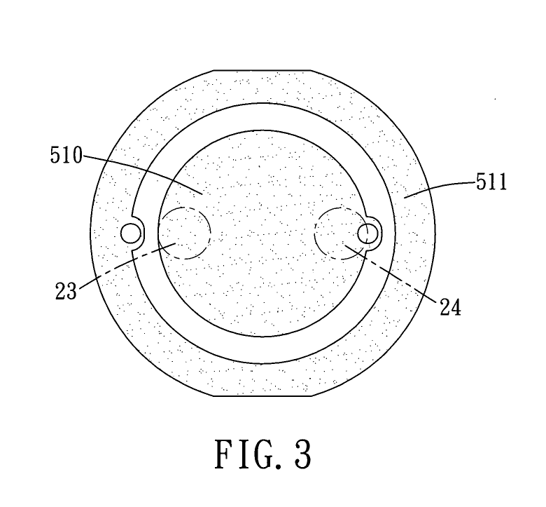

The substrate 51 and the condenser 52 are disposed within the rear barrel housing 401. The lens 53 and the protective cap 54 are disposed within the front barrel housing 400. The lamp 50 is mounted on the center of the substrate 51, and extends through a central hole 520 in the condenser 52. With further reference to FIG. 3, the substrate 51 has a rear side surface formed with a generally circular positive contact 510 disposed at a central portion thereof, and an annular negative contact 511 disposed along an outer periphery thereof and in electrical contact with the lamp-shielding barrel 40.

The electrical connection unit 2 includes a circuit board 20, a resistor unit consisting of a first resistor 21 and a second resistor 22, a contact unit consisting of a conductive short contact bar 23 and a conductive long contact bar 24, and a mounting seat 25.

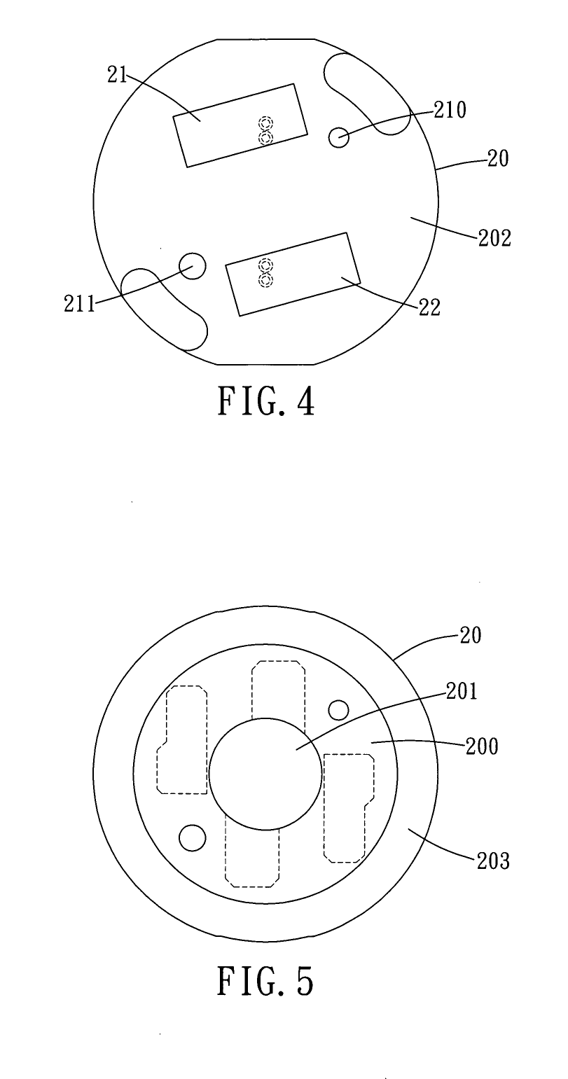

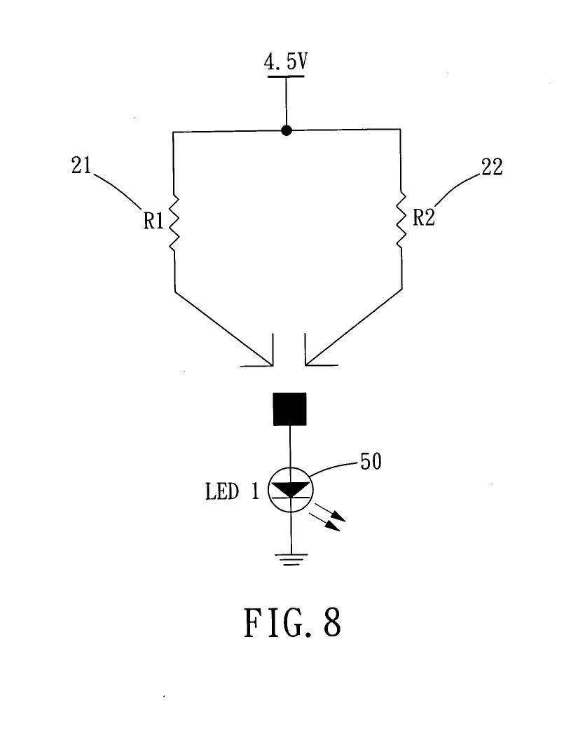

The circuit board 20 is disposed within an annular groove 410 in an inner periphery of an annular front end surface 410 of the battery housing 41. With further reference to FIGS. 4 and 5, the circuit board 20 has opposite front and rear side surfaces 202, 200. The rear side surface 200 has a positive contact 201 disposed at a central portion thereof and in electrical contact with a front end 30 of the battery set 3, and an annular negative contact 203 disposed along an outer periphery of the circuit board 20 and in electrical contact with the battery housing 41. The first and second resistors 21, 22 are attached to the front side surface 202, and are electrically connected in parallel to the positive contact 201, as shown in FIG. 8. The front side surface 202 has first and second contacts 210, 211 are connected respectively and electrically to the first and second resistors 23, 24.

The pushbutton-type switch 42 is movable on the battery housing 41 between an ON position (not shown) whereat the battery-engaging spring 420 is in electrical contact with the battery housing 41, and an OFF position shown in FIG. 2 whereat the battery-engaging spring 420 is not in electrical contact with the battery housing 41.

The resilient member 1 is disposed between the substrate 51 and the circuit board 20 so as to move the substrate 51 and the circuit board 20 away from each other. Hence, the circuit board 20 is confined within the groove 410, and the substrate 51 is biased to abut against the condenser 52. As such, the substrate 51 and the circuit board 20 are disposed respectively and fixedly within the lamp-shielding barrel 40 and the battery housing 41.

The mounting seat 25 is disposed fixedly on the front side surface 202 of the circuit board 20, and has two bar-receiving holes 250, 251 for receiving the short and long contact bars 23, 24 respectively and movably therewithin.

The short and long contact bars 23, 24 extend between the circuit board 20 and the substrate 51 along an axial direction (A), and have front ends extending outwardly of the mounting seat 25 and biased to different axial positions adjacent to the substrate 51 by two coiled compression springs (not shown), respectively. The two coiled compression springs are disposed within the mounting seat 25, and are in electrical contact with the first and second contacts 210, 211 of the circuit board 20, respectively.

The circuit board 20 has an outer periphery disposed around that of the mounting seat 25 to define an annular peripheral portion 204 of the circuit board 20 therebetween.

In this embodiment, the resilient member 1 is configured as a coiled compression spring, is sleeved on the mounting seat 25, and has front and rear ends abutting respectively against the substrate 51 and the circuit board 20.

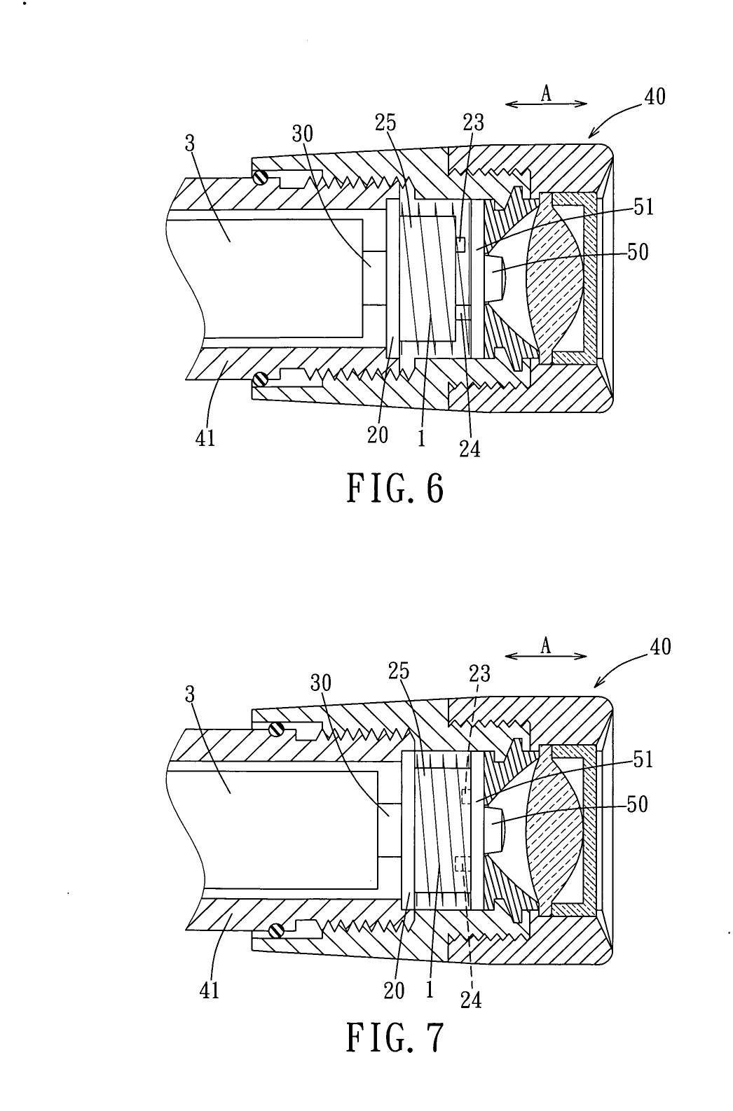

When it is desired to use the flashlight for illumination, the pushbutton-type switch 42 is pressed to the ON position to connect electrically the battery-engaging spring 420 to the battery housing 41, the lamp-shielding barrel 40, and the annular negative contact 511 of the substrate 51. Besides, the lamp-shielding barrel 40 is rotated relative to the battery housing 41 to move the substrate 51 toward the circuit board 20 from an idle position shown FIG. 1 to a first position shown in FIG. 6 whereat the positive contact 510 of the substrate 51 is in electrical contact with the long contact bar 24 and, thus, the positive contact 201 of the circuit board 20 so that the lamp 50 emits a light of a first brightness. Subsequently, to adjust the light brightness, the lamp-shielding barrel 40 is further rotated relative to the battery housing 41 to move the substrate 51 toward the circuit board 20 to a second position shown in FIG. 7 whereat the positive contact 510 of the substrate 51 is in electrical contact with both of the short and long contact bars 23, 24 so that the lamp 50 emits a light of a second brightness that is different from the first brightness.

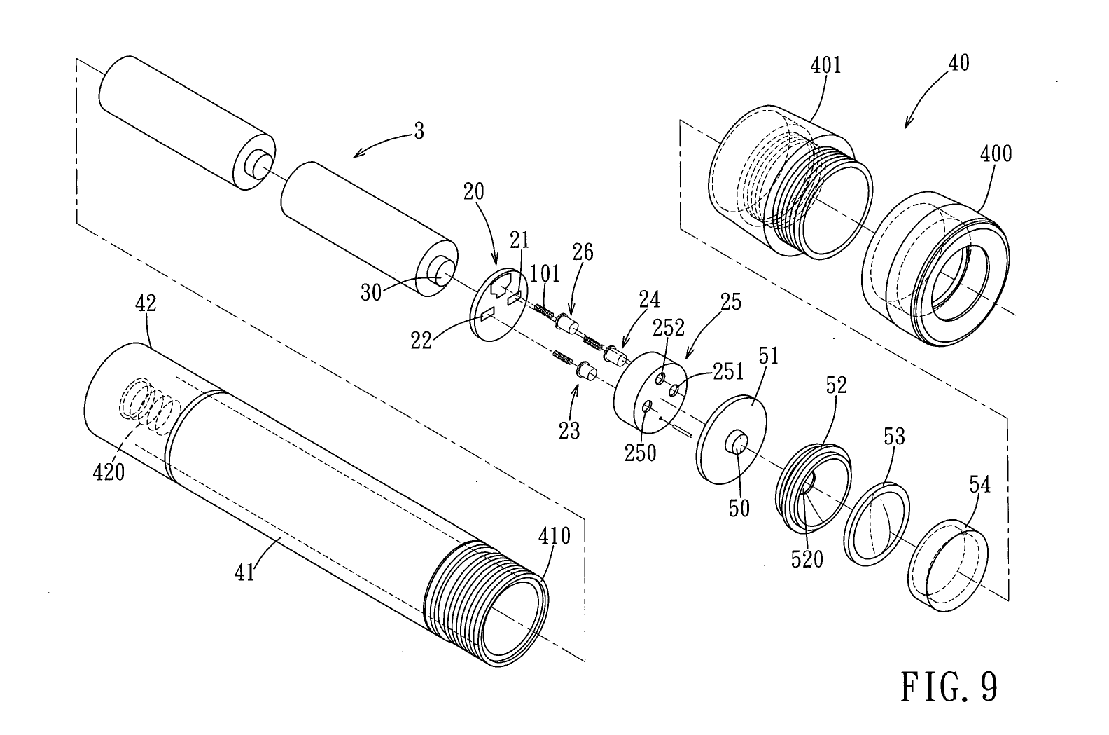

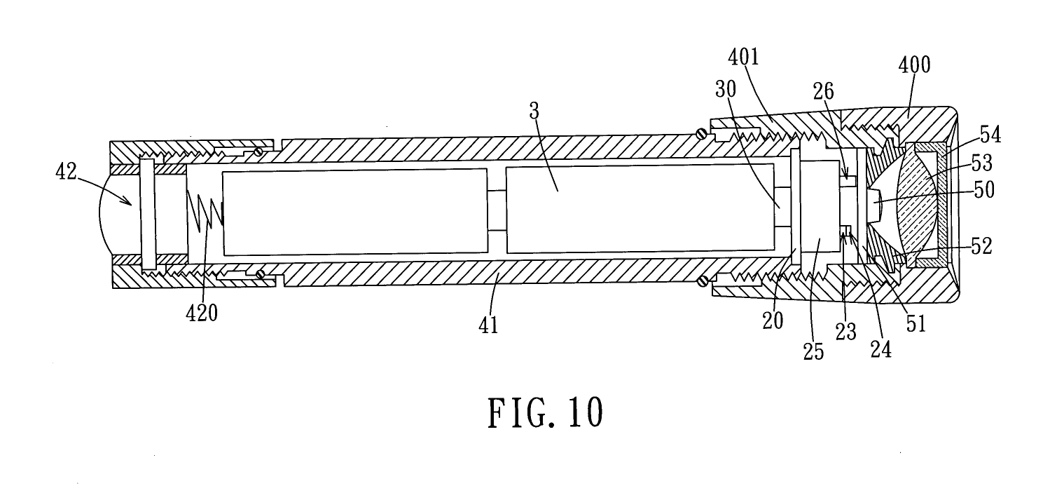

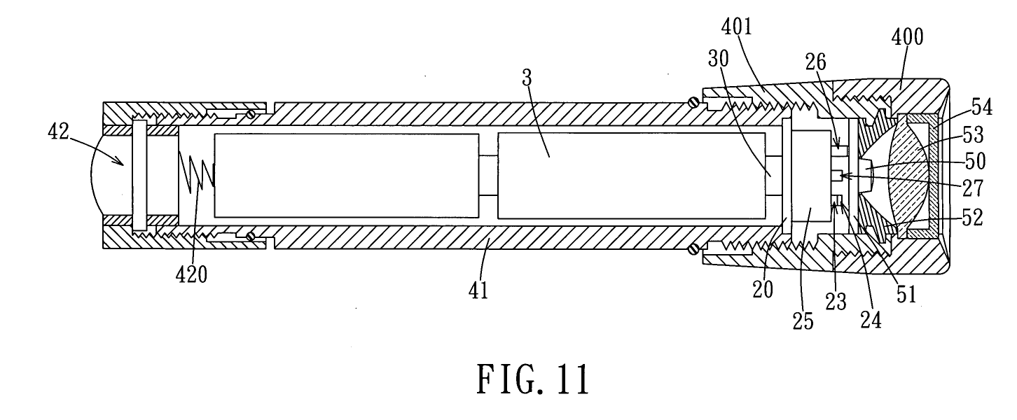

FIGS. 9 and 10 show the second preferred embodiment of an LED flashlight according to this invention, which is similar in construction to the first preferred embodiment. In this embodiment, the resilient member 1 (see FIG. 1) is omitted, and the contact unit further includes a first additional contact bar 26, and the mounting seat 25 further has an additional bar-receiving hole 252 for receiving the first additional contact bar 26 movably. The first additional contact bar 26 is longer than the long contact bar 24 to increase a selection for the light brightness. An additional spring 101 is provided to bias a front end of the first additional contact bar 26 to a predetermined axial position. The first and second resistors 21, 22 are electrically connected in parallel or in series to the first additional contact bar 26. Alternatively, with reference to FIG. 11, the contact unit may further include a second additional contact bar 27 that is longer than the long contact bar 24 and shorter than the first additional contact bar 26.

With this invention thus explained, it is apparent that numerous modifications and variations can be made without departing from the scope and spirit of this invention. It is therefore intended that this invention be limited only as indicated by the appended claims.

I claim:

1. An LED flashlight comprising:
a conductive lamp-shielding barrel;
a substrate disposed fixedly within said lamp-shielding barrel and having a positive contact disposed at a central portion thereof, and an annular negative contact disposed along an outer periphery thereof and in electrical contact with said lamp-shielding barrel;
a lamp unit mounted to said substrate;
a conductive battery housing adapted for mounting of a battery unit therewithin, said battery housing being connected rotatably to and in electrical contact with said lamp-shielding barrel and being rotatable relative to said lamp-shielding barrel so as to move toward and away from said lamp-shielding barrel; and
an electrical connection unit including
a circuit board disposed fixedly within said battery housing and having front and rear side surfaces, said rear side surface having a positive contact disposed at a central portion thereof and adapted for electrical contact with a battery set, and an annular negative contact disposed along an outer periphery of said circuit board and in electrical contact with said battery housing,
a resistor unit including at least two resistors attached to said front side surface of said circuit board and connected electrically to said positive contact of said circuit board, and
a contact unit including at least two conductive contact bars extending between said circuit board and said substrate along an axial direction and having front ends biased to different axial positions adjacent to said substrate, each of said conductive contact bars being connected electrically to said resistor unit;
wherein, when said lamp-shielding barrel is rotated relative to said battery housing to move said substrate toward said circuit board to a first position, said positive contact of said substrate is in electrical contact with one of said conductive contact bars so that said lamp unit emits a light of a first brightness; and when said lamp-shielding barrel is further rotated relative to said battery housing to move said substrate toward said circuit board to a second position, said positive contact of said substrate is in electrical contact with both of said conductive contact bars so that said lamp unit emits a light of a second brightness that is different from said first brightness.

2. The LED flashlight as claimed in claim 1, wherein the number of said conductive contact bars of said contact unit corresponds to that of said resistors of said resistor unit.

3. The LED flashlight as claimed in claim 1, wherein said contact unit includes three said conductive contact bars, and said resistor unit includes three said resistors.

4. The LED flashlight as claimed in claim 1, wherein:
said positive contact of said circuit board is generally circular;
said conductive contact bars are connected respectively and electrically to said resistors;
said electrical connection unit further includes a mounting seat disposed fixedly on said front side surface of said circuit board and having two bar-receiving holes for receiving said conductive contact bars respectively and movably therewithin such that said front ends of said conductive contact bars extend outwardly of said mounting seat, said circuit board having an outer periphery disposed around that of said mounting seat to define an annular peripheral portion of said circuit board therebetween; and
said resilient member is configured as a coiled compression spring, is sleeved on said mounting seat, and has front and rear ends abutting respectively against said substrate and said circuit board.

5. The LED flashlight as claimed in claim 1, wherein:
said positive contact of said circuit board is generally circular;
said contact unit includes three said conductive contact bars each connected electrically to said resistor unit;
said electrical connection unit further includes a mounting seat disposed fixedly on said front side surface of said circuit board and having three bar-receiving holes for receiving said conductive contact bars respectively and movably therewithin such that said front ends of said conductive contact bars extend outwardly of said mounting seat, said circuit board having an outer periphery disposed around that of said mounting seat to define an annular peripheral portion of said circuit board therebetween; and
said resilient member is configured as a coiled compression spring, is sleeved on said mounting seat, and has front and rear ends abutting respectively against said substrate and said circuit board.

6. The LED flashlight as claimed in claim 1, further comprising a resilient member disposed between said substrate and said circuit board of said electrical connection unit for biasing said substrate and said circuit board to move away from each other.
